(19) United States
(12) Patent Application Publication
(10) Pub. No.: US 2010/0306999 A1
(43) Pub. Date: Dec. 9, 2010

(54) CURRENT TERMINAL STRUCTURE

(76) Inventor: Szu-Chi Huang, Taoyuan County (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/479,008

(22) Filed: Jun. 5, 2009

(51) Int. Cl. H01R 43/00

(52) U.S. Cl. 29/882

(57) ABSTRACT

A current terminal structure includes: a mutual inductor having a noose portion; and a conductor configured to be coupled to the mutual inductor and bent to form at least a connection segment and bend segments extending from the connection segment bilaterally, wherein a terminal portion is defined at each of the bend segments by pressing; wherein the coupling of the conductor and the mutual inductor together comprises looping the noose portion of the mutual inductor around one of the bend segments of the conductor and then moving the noose portion of the mutual inductor to the connection segment of the conductor before the bending and pressing are performed on the conductor. Therefore, the current terminal structure is provided with the downsized mutual inductor and thus characterized by a diminished waste of materials, reduced manufacturing costs, and ease of use.

### FIELD OF THE INVENTION

The present invention relates to current terminal structures, and more particularly, to a current terminal structure provided with a downsized mutual inductor and thus characterized by a diminished waste of materials, reduced manufacturing costs, and ease of use.

### BACKGROUND OF THE INVENTION

Referring to FIGS. 1, 2 and 3, a conventional current terminal comprises a conductor 3 and a mutual inductor 4. The conductor 3 has a connection segment 31 and two terminal portions 32. The mutual inductor 4 has a noose portion 41. The terminal portions 32 are coupled to two ends of the connection segment 31, respectively, by welding. The inner diameter of the noose portion 41 of the mutual inductor 4 is greater than the outer diameter of the terminal portions 32 of the conductor 3. An assembly process performed on the conventional current terminal involves putting the noose portion 41 of the mutual inductor 4 around one of the terminal portions 32 of the conductor 3, moving the mutual inductor 4 until the mutual inductor 4 reaches the connection segment 31, and filling the space between the noose portion 41 and the connection segment 31 with a filler 42 so as for the mutual inductor 4 to be fixed in position to the conductor 3. In practice, the terminal portions 32 of the conductor 3 can be connected to related electronic equipment (not shown), such as a meter, electric meter, or measurement instrument, so as for the conventional current terminal to detect current.

Although the conventional current terminal is fit for detection of current of related electronic equipment when connected thereto, it has its own drawbacks. The conductor 3 and the mutual inductor 4 of the conventional current terminal are manufactured and marketed separately. To make assembly simpler, looping the mutual inductor 4 around the conductor 3 has to be easy. However, ease of assembly cannot be achieved unless the inner diameter of the noose portion 41 of the mutual inductor 4 is greater than the outer diameter of the terminal portions 32. Hence, the mutual inductor 4 of the conventional current terminal is always oversized at the cost of a waste of materials and an increase in manufacturing costs. Furthermore, it is inconvenient for a user to loop the mutual inductor 4 around the conductor 3 and then fix the mutual inductor 4 to the conductor 3 by means of the filler 42.

Therefore, the manufacturers are confronted with an urgent issue which involves developing a current terminal structure provided with a downsized mutual inductor and thus characterized by a diminished waste of materials, reduced manufacturing costs, and ease of use.

### SUMMARY OF THE INVENTION

In view of the aforesaid drawbacks of the prior art, the inventor of the present invention believes that there is room for improvement in the conventional current terminal structure and finally succeeded, based on years of practical experience and after conducting pertinent research and experiments, in developing a current terminal structure provided with a downsized mutual inductor and thus characterized by a diminished waste of materials, reduced manufacturing costs, and ease of use.

It is a primary objective of the present invention to provide a current terminal structure comprising a conductor and a mutual inductor and characterized in that a method for manufacturing the current terminal structure involves coupling the conductor and the mutual inductor together, bending two ends of the conductor, and forming two terminal portions from the two bent ends of the conductor, respectively, by pressing, such that the downsized mutual inductor enables a diminished waste of materials, reduced manufacturing costs, and ease of use.

To achieve the above and other objectives, the present invention provides a current terminal structure, comprising: a mutual inductor having a noose portion; and a conductor configured to be coupled to the mutual inductor and bent to form at least a connection segment and bend segments extending from the connection segment bilaterally, wherein a terminal portion is defined at each of the bend segments by pressing; wherein the coupling of the conductor and the mutual inductor together comprises looping the noose portion of the mutual inductor around one of the bend segments of the conductor and then moving the noose portion of the mutual inductor to the connection segment of the conductor before the bending and pressing is performed on the conductor.

Hence, a current terminal structure of the present invention is provided with a downsized mutual inductor and thus characterized by a diminished waste of materials, reduced manufacturing costs, and ease of use.

### BRIEF DESCRIPTION OF THE DRAWINGS

To enable persons skilled in the art to gain insight into the objectives, features, and effects of use of the present invention, the present invention is hereunder illustrated with preferred embodiments in conjunction with the accompanying drawings, wherein:

FIG. 1 (PRIOR ART) is an exploded view of a conventional current terminal structure;

FIG. 2 (PRIOR ART) is a perspective view of the conventional current terminal structure during an assembly process;

FIG. 3 (PRIOR ART) is a perspective view of the conventional current terminal structure after the assembly process;

FIG. 4 is a perspective view of a mutual inductor and a conductor of a current terminal structure before an assembly process is performed on the current terminal structure according to a first embodiment of the present invention;

FIG. 5 is a perspective view of the mutual inductor and the conductor coupled together according to the first embodiment of the present invention;

FIG. 6 is a perspective view showing the conductor bent according to the first embodiment of the present invention;

FIG. 7 is a perspective view showing the mutual inductor fixed in position to the conductor according to the first embodiment of the present invention;

FIG. 8 is a perspective view showing that terminal portions of the conductor are formed by pressing according to the first embodiment of the present invention;

FIG. 9 is a perspective view of the finalized current terminal structure according to the first embodiment of the present invention;

FIG. 10 is a perspective view of a conductor of a current terminal structure according to a second embodiment of the present invention;

FIG. 11 is a perspective view of the mutual inductor and the conductor coupled together according to the second embodiment of the present invention;

FIG. 12 is a perspective view showing the conductor bent according to the second embodiment of the present invention;

FIG. 13 is a perspective view showing that terminal portions of the conductor are formed by pressing according to the second embodiment of the present invention; and

FIG. 14 is a perspective view of the current terminal structure finalized according to the second embodiment of the present invention.

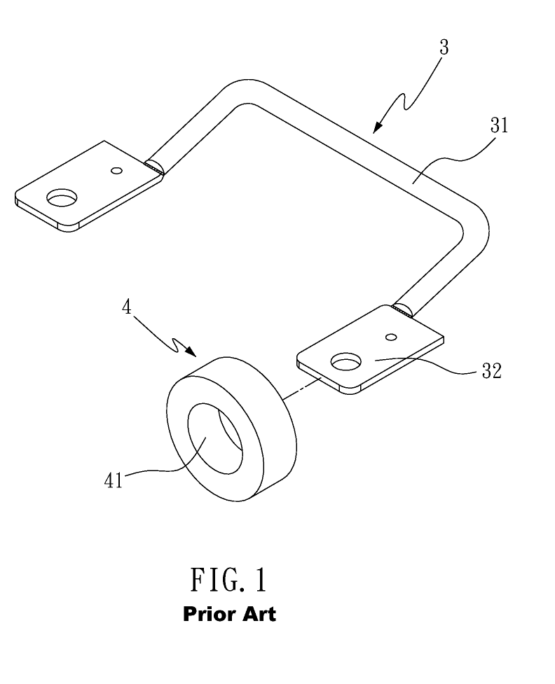

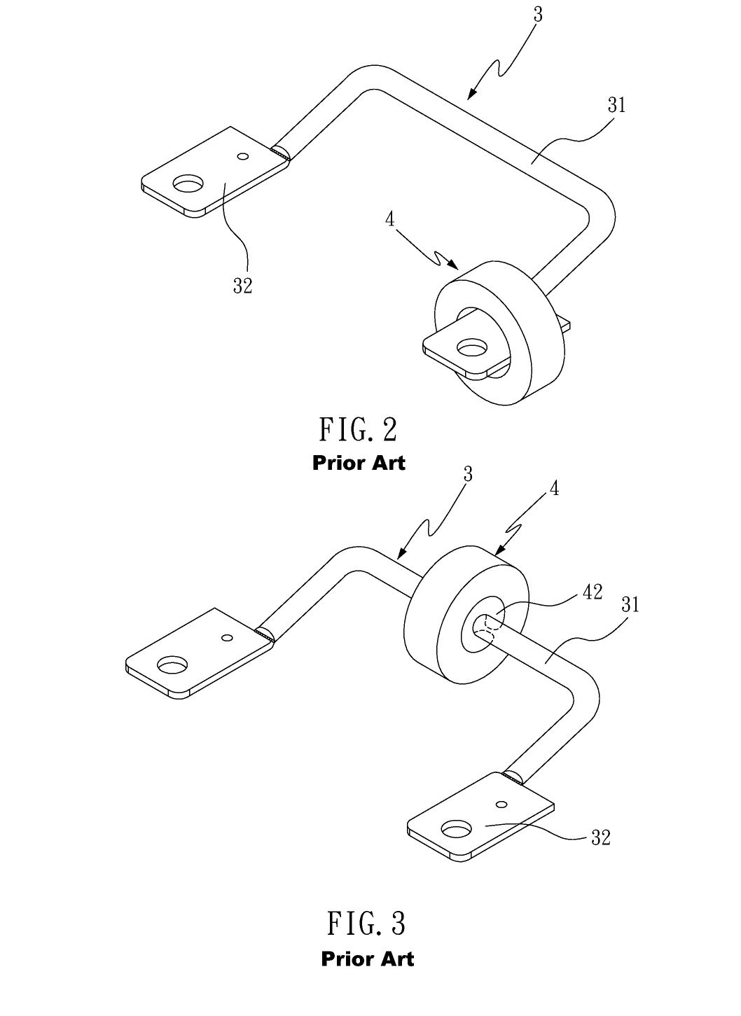

### DETAILED DESCRIPTION OF THE EMBODIMENTS

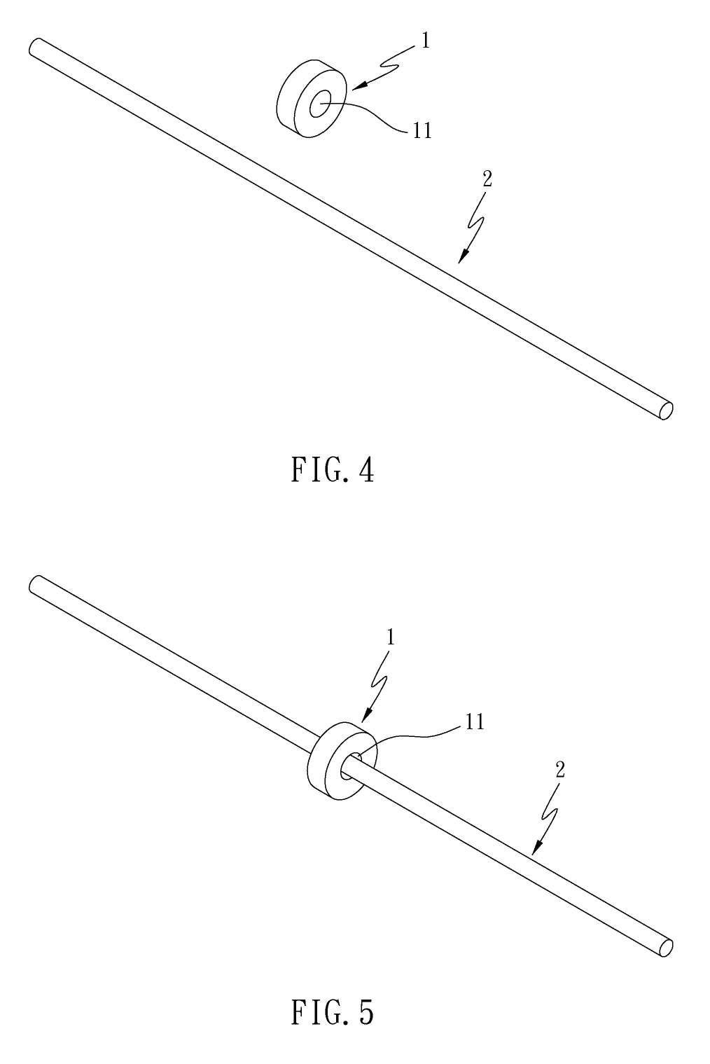

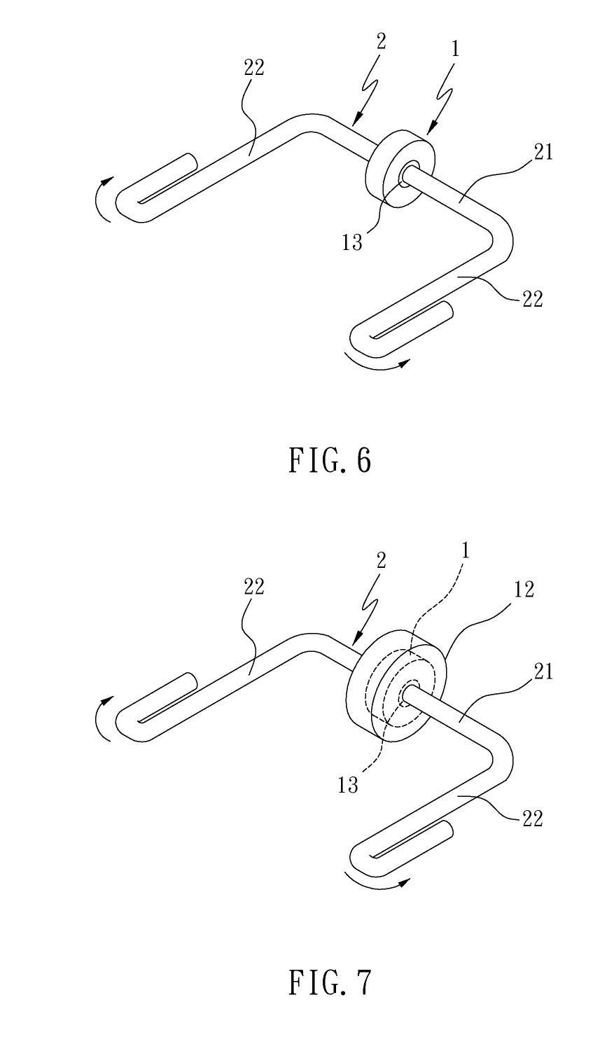

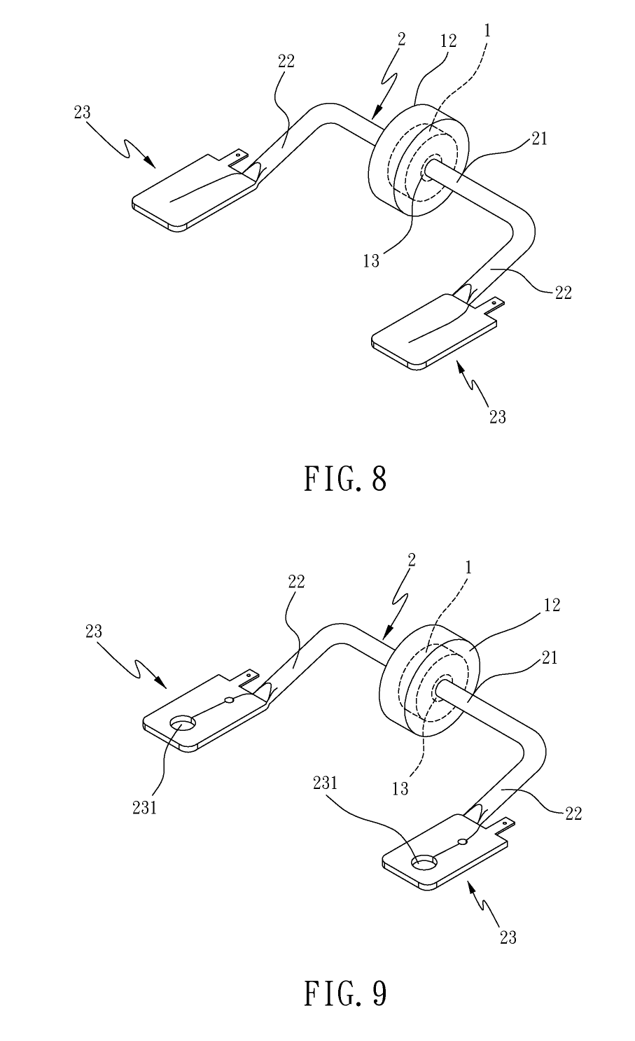

Referring to FIGS. 4, 5, 6, 7, 8 and 9, diagrams of a conductor and a mutual inductor of a current terminal structure, the conductor and mutual inductor coupled together, the conductor bent, the mutual inductor fixed in position to the conductor, terminal portions formed by pressing, and the current terminal structure finalized according to a first embodiment of the present invention are shown, respectively. As shown in the drawings, the current terminal structure of the present invention comprises at least a mutual inductor 1 and a conductor 2. The conductor 2 and the mutual inductor 1 are configured to be coupled together by an assembly process performed on the current terminal structure of the present invention. The mutual inductor 1 has a noose portion 11. The conductor 2, which is made of copper, has a connection segment 21 and two bend segments 22 extending from the connection segment 21 bilaterally. At the beginning of an assembly process performed on the current terminal structure of the present invention, the noose portion 11 of the mutual inductor 1 is looped around the connection segment 21 of the conductor 2.

The assembly process performed on the current terminal structure according to the first embodiment of the present invention is described hereunder. The assembly process comprises the steps of: looping the noose portion 11 of the mutual inductor 1 around the conductor 2; moving the noose portion 11 of the mutual inductor 1 until the noose portion 11 reaches the middle of the conductor 2; bending the conductor 2 so as to form therefrom the connection segment 21 and the two bend segments 22 extending from the connection segment 21 bilaterally; bending the ends of the bend segments 22, respectively, while the mutual inductor 1 is positioned at the connection segment 21 of the conductor 2; fixing the mutual inductor 1 in position to the connection segment 21 of the conductor 2 using a heat-resistant plastic casing 12 and a C-shaped pad 13 (or heat-resistant plastic); pressing each of the bent ends of the bend segments 22 so as for a terminal portion 23 to be defined from each of the bent ends of the bend segments 22 using an appropriate tool (not shown), and forming two positioning holes 231 in the terminal portions 23, respectively, during the pressing of each of the bent ends of the bend segments 22; and plating tin to the terminal portions 23. Upon completion of the assembly process, the current terminal structure is provided with the downsized mutual inductor 1 and thus characterized by a diminished waste of materials, reduced manufacturing costs, and ease of use.

In practice, related electronic equipment (not shown), such as a meter, electric meter, or measurement instrument, is connected to the positioning holes 231 of the terminal portions 23 of the conductor 2 by fasteners, and a related test instrument (not shown) is connected to the mutual inductor 1 by a wire, such that current of the powered-on electronic equipment can be detected as a result of electromagnetic induction effectuated by the mutual inductor 1 and the conductor 2.

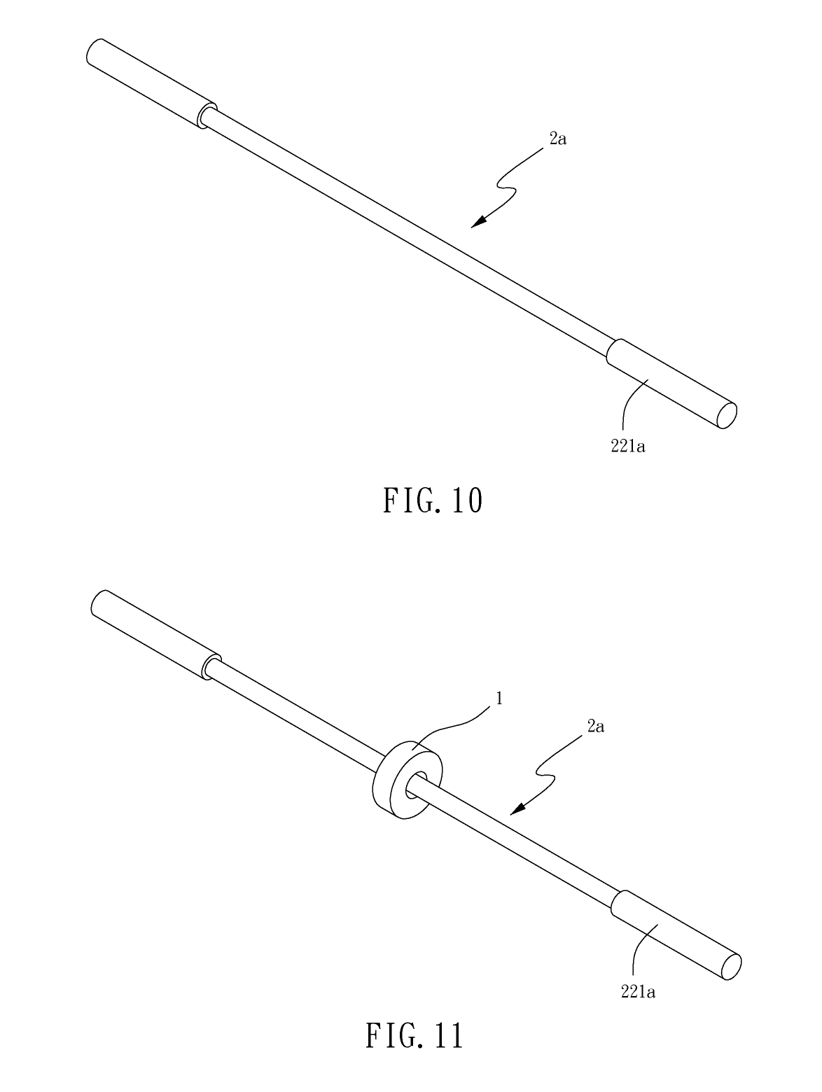

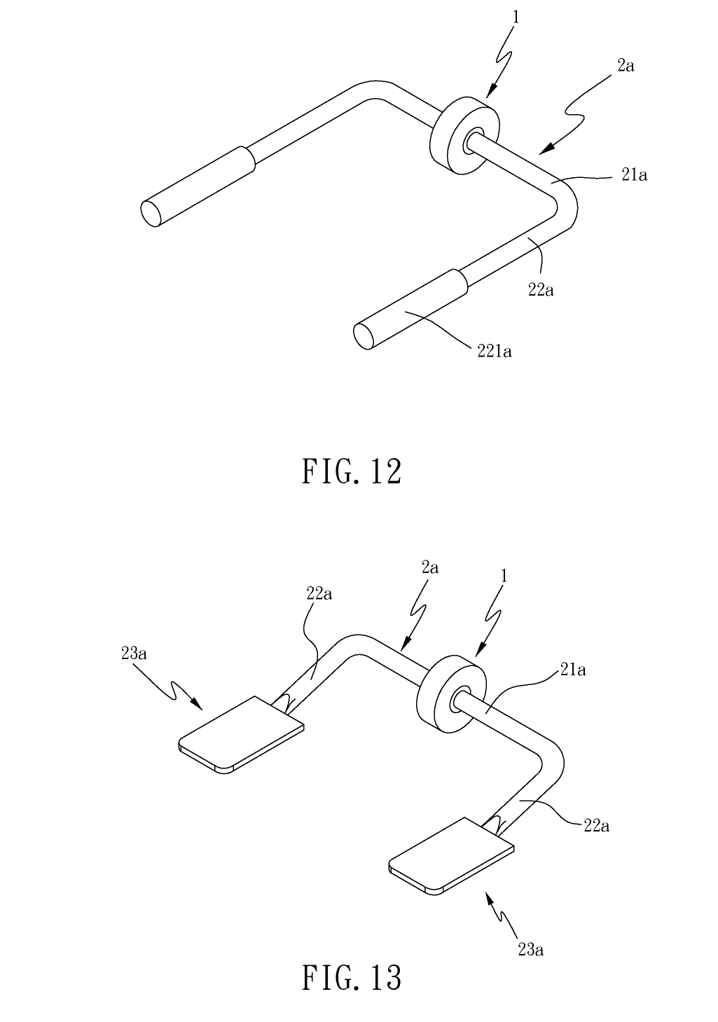

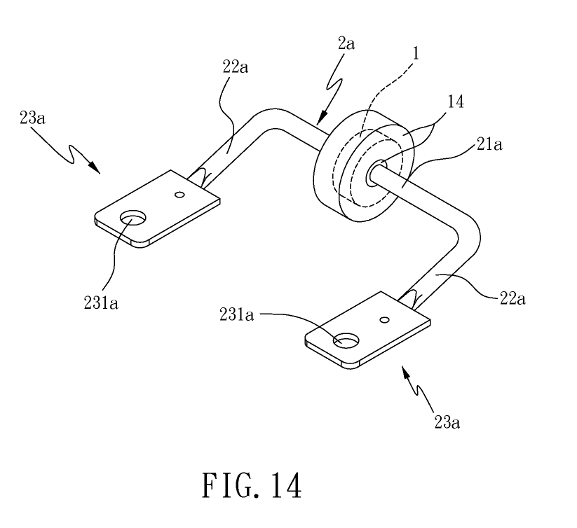

Referring to FIGS. 10, 11, 12, 13, and 14, diagrams of a conductor of a current terminal structure, the conductor and a mutual inductor coupled together, the conductor bent, terminal portions formed by pressing, and the current terminal structure finalized according to a second embodiment of the present invention are shown, respectively. As shown in the drawings, in the second embodiment of the present invention, a thickened region 221a is provided to the end of each of bend segments 22a of a conductor 2a and has a greater outer diameter than a connection segment 21a of the conductor 2a.

The assembly process performed on the current terminal structure according to the second embodiment of the present invention is described hereunder. The assembly process comprises the steps of: looping the noose portion 11 of the mutual inductor 1 around the conductor 2a; moving the noose portion 11 of the mutual inductor 1 until the noose portion 11 reaches the middle of the conductor 2a; bending the conductor 2a so as to form therefrom the connection segment 21a and the two bend segments 22a extending from the connection segment 21a bilaterally; applying heat-resistant plastic 14 to the noose portion 11 until the heat-resistant plastic 14 fills the noose portion 11 and encapsulates the mutual inductor 1 such that the mutual inductor 1 is fixed in position to the connection segment 21a; and pressing the thickened regions 221a of the conductor 2a such that a terminal portion 23a having a positioning hole 231a formed therein is defined at the end of each of the bend segment 22a. The second embodiment equals the first embodiment in effect.

As described above, a current terminal structure of the present invention meets the three conditions for patentability, namely novelty, involving an inventive step, and high industrial applicability. The present invention which provides the current terminal structure comprising a mutual inductor and a conductor is novel and involves an inventive step, because the present invention discloses looping the mutual inductor around the conductor, then bending two ends of the conductor, and finally pressing the two bent ends of the conductor so as for a terminal portion to be defined at each of the bent ends of the conductor, and in consequence the current terminal structure of the present invention is provided with the downsized mutual inductor and thus characterized by a diminished waste of materials, reduced manufacturing costs, and ease of use. The present invention has high industrial applicability, because the current terminal structure of the present invention meets the demand of the market nowadays.

Preferred embodiments of the present invention are described above. Persons skilled in the art should be able to understand that the preferred embodiments serve to illustrate the present invention rather than limit the scope of application of the present invention. It should be noted that all equivalent changes of or replacements for the preferred embodiments fall within the scope of disclosure of the present invention. Hence, the scope of protection for the present invention should be defined by the claims as found hereunder.

What is claimed is:

1. A current terminal structure, comprising:
a mutual inductor having a noose portion; and
a conductor configured to be coupled to the mutual inductor and bent to form at least a connection segment and bend segments extending from the connection segment bilaterally, wherein a terminal portion is defined at each of the bend segments by pressing;
wherein the coupling of the conductor and the mutual inductor together comprises looping the noose portion of the mutual inductor around one end of the conductor and then moving the noose portion of the mutual inductor to the connection segment of the conductor before the bending and pressing are performed on the conductor;
wherein the noose portion has an inner diameter with an inner circumference;
wherein the terminal portion has a width;
wherein the connection segment of the conductor has an outer circumference;
wherein the inner diameter of the noose portion is smaller than the width of the terminal portion; and
the inner circumference of the noose portion is substantially same as the outer circumference of the connection segment of the conductor.

2. The current terminal structure of claim 1, wherein the coupling of the conductor and the mutual inductor together further comprises fixing the mutual inductor in position to the conductor using a heat-resistant plastic casing.

3. The current terminal structure of claim 1, wherein the conductor is made of copper.

4. The current terminal structure of claim 1, wherein a thickened region of a greater outer diameter than the connection segment is provided to an end of each of the bend segments and is pressed immediately after being penetrated by the mutual inductor so as for the terminal portion to be defined at the thickened region.

5. The current terminal structure of claim 1, wherein the bend segments are bent and then pressed.

6. The current terminal structure of claim 1, wherein positioning holes are formed in the terminal portions, respectively, and tin is plated to the terminal portions.
